(19) United States
(12) Patent Application Publication
(10) Pub. No.: US 2018/0268007 A1
(43) Pub. Date: Sep. 20, 2018

(54) MEANS FOR INDUCTIVELY POPULATING A COMPACTABLE TIER SET, TENTATIVE ESTASBLISHING OR RULING OUT THE EXISTENCE OF CERTAIN MLMD COMMON SUBSEQUENCES AMONG TWO OR MORE SEQUENCES, AND IDENTIFYING ONE OR MORE TEXT INTERSECTION GROUPS AMONG TWO OR MORE TEXT SEGMENTS

(71) Applicant: Richard Salisbury, Austin, TX (US)

(72) Inventor: Richard Salisbury, Austin, TX (US)

(21) Appl. No.: 15/898,493

(22) Filed: Feb. 17, 2018

Related U.S. Application Data
(60) Provisional application No. 62/460,154, filed on Feb. 17, 2017.

(51) Int. Cl. G06F 17/30

(52) U.S. Cl. CPC G06F 17/30321; G06F 17/30371

(57) ABSTRACT

A method of a method of inductively populating a compactable tier set. The method can include obtaining two or more component sequences. The method can also include designating one of the sequences as the primary sort-order sequence the method can also include populating a locations index for one or more component sequences other than the primary sort-order component sequence. The method can also include adding each locations index to a locations index set. The method can also include creating and initializing a primary sort-order item counter. The method can also include creating a compactable tier set. The method can also include creating a generated location n-tuples container. The method can also include determining whether each locations index in the locations index set contains an associated locations list associated with the primary sort-order cursor item. The method can also include generating a smallest primary sort-order location n-tuple when each locations index in the locations index set contains an associated locations list associated with the primary sort-order cursor item. The method can also include determining whether the compactable tier set is empty. The method can also include creating a new compactable tier, adding the smallest primary sort-order location n-tuple to the newly-created compactable tier and adding the newly-created compactable tier to the compactable tier set when the compactable tier set is empty. The method can also include emptying the generated location n-tuples container when the compactable tier set is not empty. The method can also include creating a compactable tier countdown counter and initializing it so that it references the most recently created compactable tier in the compactable tier set. The method can also include creating a compactable tier location n-tuple counter and initializing it so that it references the first location n-tuple in current compactable tier. The method can also include attempting to generate a smallest unambiguously larger primary sort-order location n-tuple with respect to the current compactable tier current location n-tuple. The method can also include determining whether a smallest unambiguously larger primary sort-order location n-tuple was generated. The method can also include determining whether the generated location n-tuples container contains a location n-tuple that is smaller than or equal to the smallest unambiguously larger primary sort-order location n-tuple when a smallest unambiguously larger primary sort-order location n-tuple was generated. The method can also include adding the smallest unambiguously larger primary sort-order location n-tuple to the generated location n-tuples container when the generated location n-tuples container does not contain a location n-tuple that is smaller than or equal to the smallest unambiguously larger primary sort-order location n-tuple. The method can also include determining whether the current compactable tier is the most recently created compactable tier in the compactable tier set. The method can also include creating a new compactable tier, adding the smallest unambiguously larger primary sort-order location n-tuple to the newly-created compactable tier and adding the newly-created compactable tier to the compactable tier set when the current compactable tier is the most recently created compactable tier in the compactable tier set. The method can also include attempting to place the smallest unambiguously larger primary sort-order location n-tuple into the compactable tier that was added to the compactable tier set immediately after the current compactable tier when the current compactable tier is not the most recently created compactable tier in the compactable tier set. The method can also include determining whether the current compactable tier current location n-tuple is the last location n-tuple in the current compactable tier. The method can also include adjusting the compactable tier location n-tuple counter so that it references the next location n-tuple in the current compactable tier when the current compactable tier current location n-tuple is not the last location n-tuple in the current compactable tier. The method can also include determining whether the current compactable tier is the first-created compactable tier in the compactable tier set when the current compactable tier current location n-tuple is the last location n-tuple in the current compactable tier. The method can also include adjusting the compactable tier countdown counter so that it references the compactable tier that was added to compactable tier set immediately before the current compactable tier when the current compactable tier is not the first-created compactable tier in the compactable tier set. The method can also include adjusting the compactable tier location n-tuple counter so that it references the first location n-tuple in the compactable tier referenced by the current value of the compactable tier countdown counter. The method can also include determining whether the generated location n-tuples container contains a location n-tuple that is smaller than or equal to the smallest primary sort-order location n-tuple. The method can also include attempting to place the smallest primary sort-order location n-tuple into the first-created compactable tier in the compactable tier set when the generated location n-tuples container does not contain a location n-tuple that is smaller than or equal to the smallest primary sort-order location n-tuple. The method can also include adjusting the primary sort-order item counter.

### CROSS-REFERENCE TO RELATED APPLICATIONS

This application claims the benefit of and priority to U.S. Provisional Patent Application Ser. No. 62/460,154 filed on Feb. 17, 2017, which application is incorporated herein by reference in its entirety.

This application is a continuation-in-part of, and claims the benefit of and priority to, U.S. patent application Ser. No. 14/924,425 filed on Oct. 27, 2015, which application is incorporated herein by reference in its entirety.

U.S. Non-Provisional patent application Ser. No. 14/924,425 claims the benefit of and priority to U.S. Provisional Patent Application Ser. No. 62/073,128 filed on Oct. 31, 2014, which application is incorporated herein by reference in its entirety.

U.S. Non-Provisional patent application Ser. No. 14/924,425 claims the benefit of and priority to U.S. Provisional Patent Application Ser. No. 62/083,842 filed on Nov. 24, 2014, which application is incorporated herein by reference in its entirety.

U.S. Non-Provisional patent application Ser. No. 14/924,425 claims the benefit of and priority to U.S. Provisional Patent Application Ser. No. 62/170,095 filed on Jun. 2, 2015, which application is incorporated herein by reference in its entirety.

This application is a continuation-in-part of, and claims the benefit of and priority to, U.S. patent application Ser. No. 15/263,200 filed on Sep. 12, 2016, which application is incorporated herein by reference in its entirety.

U.S. Non-Provisional patent application Ser. No. 15/263,200 claims the benefit of and priority to U.S. Provisional Patent Application Ser. No. 62/217,826 filed on Sep. 12, 2015, which application is incorporated herein by reference in its entirety.

U.S. Non-Provisional patent application Ser. No. 15/263,200 claims the benefit of and priority to U.S. Provisional Patent Application Ser. No. 62/249,872 filed on Nov. 2, 2015, which application is incorporated herein by reference in its entirety.

U.S. Non-Provisional patent application Ser. No. 15/263,200 claims the benefit of and priority to U.S. Provisional Patent Application Ser. No. 62/261,166 filed on Nov. 30, 2015, which application is incorporated herein by reference in its entirety.

### BACKGROUND OF THE INVENTION

U.S. patent application Ser. No. 15/263,200 (“application Ser. No. 15/263,200”) teaches means for (inter alia) generating one or more primary sort-order location n-tuples, correctly placing these primary sort-order location n-tuples into a compactable tier set and identifying, and avoiding the placement into the compactable tier set of, superfluous location n-tuples.

Although this may be implemented in multiple different manners, not all implementations are equally efficient. A particularly inefficient implementation might initially generate a large number of superfluous location n-tuples and only identify them as superfluous at a later time when an attempt is made to place one or more such location n-tuples into the compactable tier set.

Accordingly, there is a need in the art for efficient means for early detection and avoidance of superfluous location n-tuples.

U.S. patent application Ser. No. 14/924,425 (“application Ser. No. 14/924,425”) teaches means for (inter alia) using a tier set to identify certain common subsequences among one or more component sequences, including analyzing potential common subsequences to identify those that satisfy certain conditions as to minimum length and minimum density. Although such analysis may be implemented in a number of different manners, not all such implementations are equally efficient. A particularly inefficient implementation might require analysis of each and every location n-tuple located in any one or more pair of tiers that span at least the minimum length.

Accordingly, there is a need in the art for efficient means to tentatively establish or rule out the existence of certain minimum length, minimum density common subsequences among two or more component sequences.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of a method of inductively populating a compactable tier set. The method can include obtaining two or more component sequences. The method can also include designating one of the sequences as the primary sort-order sequence the method can also include populating a locations index for one or more component sequences other than the primary sort-order component sequence. The method can also include adding each locations index to a locations index set. The method can also include creating and initializing a primary sort-order item counter. The method can also include creating a compactable tier set. The method can also include creating a generated location n-tuples container. The method can also include determining whether each locations index in the locations index set contains an associated locations list associated with the primary sort-order cursor item. The method can also include generating a smallest primary sort-order location n-tuple when each locations index in the locations index set contains an associated locations list associated with the primary sort-order cursor item. The method can also include determining whether the compactable tier set is empty. The method can also include creating a new compactable tier, adding the smallest primary sort-order location n-tuple to the newly-created compactable tier and adding the newly-created compactable tier to the compactable tier set when the compactable tier set is empty. The method can also include emptying the generated location n-tuples container when the compactable tier set is not empty. The method can also include creating a compactable tier countdown counter and initializing it so that it references the most recently created compactable tier in the compactable tier set. The method can also include creating a compactable tier location n-tuple counter and initializing it so that it references the first location n-tuple in current compactable tier. The method can also include attempting to generate a smallest unambiguously larger primary sort-order location n-tuple with respect to the current compactable tier current location n-tuple. The method can also include determining whether a smallest unambiguously larger primary sort-order location n-tuple was generated. The method can also include determining whether the generated location n-tuples container contains a location n-tuple that is smaller than or equal to the smallest unambiguously larger primary sort-order location n-tuple when a smallest unambiguously larger primary sort-order location n-tuple was generated. The method can also include adding the smallest unambiguously larger primary sort-order location n-tuple to the generated location n-tuples container when the generated location n-tuples container does not contain a location n-tuple that is smaller than or equal to the smallest unambiguously larger primary sort-order location n-tuple. The method can also include determining whether the current compactable tier is the most recently created compactable tier in the compactable tier set. The method can also include creating a new compactable tier, adding the smallest unambiguously larger primary sort-order location n-tuple to the newly-created compactable tier and adding the newly-created compactable tier to the compactable tier set when the current compactable tier is the most recently created compactable tier in the compactable tier set. The method can also include attempting to place the smallest unambiguously larger primary sort-order location n-tuple into the compactable tier that was added to the compactable tier set immediately after the current compactable tier when the current compactable tier is not the most recently created compactable tier in the compactable tier set. The method can also include determining whether the current compactable tier current location n-tuple is the last location n-tuple in the current compactable tier. The method can also include adjusting the compactable tier location n-tuple counter so that it references the next location n-tuple in the current compactable tier when the current compactable tier current location n-tuple is not the last location n-tuple in the current compactable tier. The method can also include determining whether the current compactable tier is the first-created compactable tier in the compactable tier set when the current compactable tier current location n-tuple is the last location n-tuple in the current compactable tier. The method can also include adjusting the compactable tier countdown counter so that it references the compactable tier that was added to compactable tier set immediately before the current compactable tier when the current compactable tier is not the first-created compactable tier in the compactable tier set. The method can also include adjusting the compactable tier location n-tuple counter so that it references the first location n-tuple in the compactable tier referenced by the current value of the compactable tier countdown counter. The method can also include determining whether the generated location n-tuples container contains a location n-tuple that is smaller than or equal to the smallest primary sort-order location n-tuple. The method can also include attempting to place the smallest primary sort-order location n-tuple into the first-created compactable tier in the compactable tier set when the generated location n-tuples container does not contain a location n-tuple that is smaller than or equal to the smallest primary sort-order location n-tuple. The method can also include adjusting the primary sort-order item counter.

Another example embodiment includes a method of tentatively establishing or ruling out the existence of certain minimum length, minimum density common subsequences. The method can include obtaining two or more component sequences. The method can also include populating a max tier set and a max tier corresponding tier set with respect to the component sequences. The method can also include creating a max tier entry counter and initializing it to reference one of the entries in the max tier set. The method can also include identifying one or more max tier associated location n-tuples. The method can also include identifying one or more max tier location n-tuple sequences. The method can also include identifying the subset of identified max tier location n-tuple sequences that satisfy a minimum length requirement and a minimum density requirement with respect to the max component value.

Another example embodiment includes a method of a method of locating one or more text intersection groups among two or more text segments. The method can include obtaining two or more text segments. The method can also include designating a minimum length requirement. The method can also include designating a minimum density requirement. The method can also include populating one or more tier sets with respect to the text segments. The method can also include using the tier sets to identify one or more text intersection groups with respect to two or more of the text segments.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of inductively populating a compactable tier set.

FIG. 2 is a flowchart illustrating a method of tentatively establishing or ruling out the existence of certain minimum length, minimum density common subsequences.

FIG. 3 is a flowchart illustrating a method of locating one or more text intersection groups among two or more text segments; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale. Unless otherwise specifically noted, terms defined in application Ser. No. 14/924,425 or application Ser. No. 15/263,200, respectively, have the same meanings when used herein.

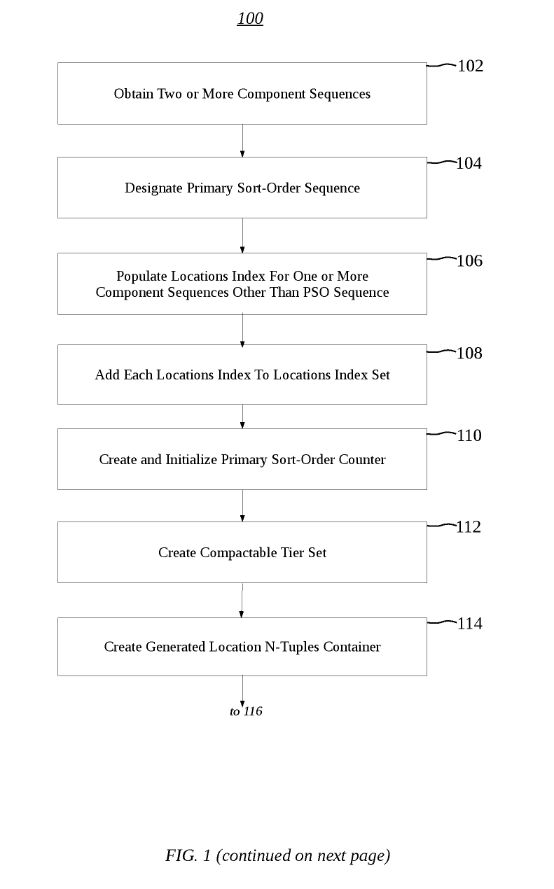

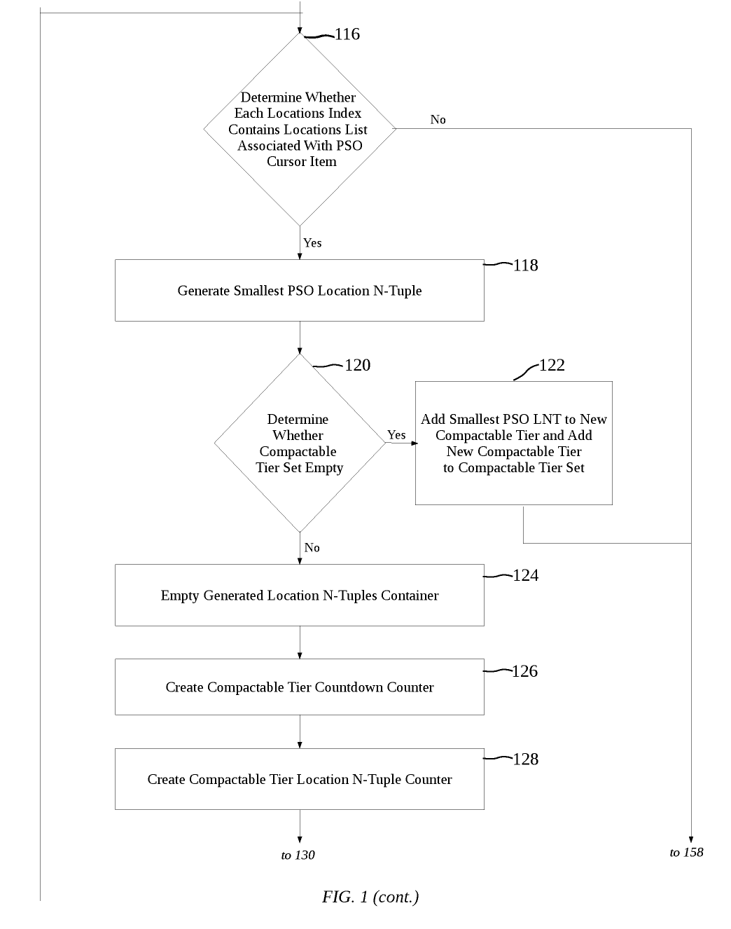

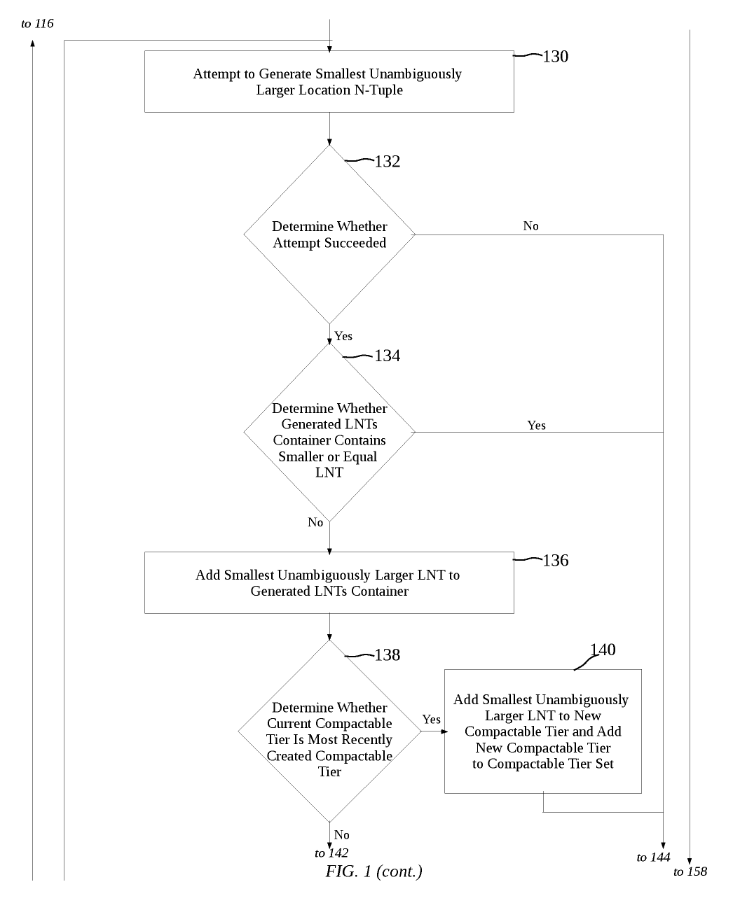

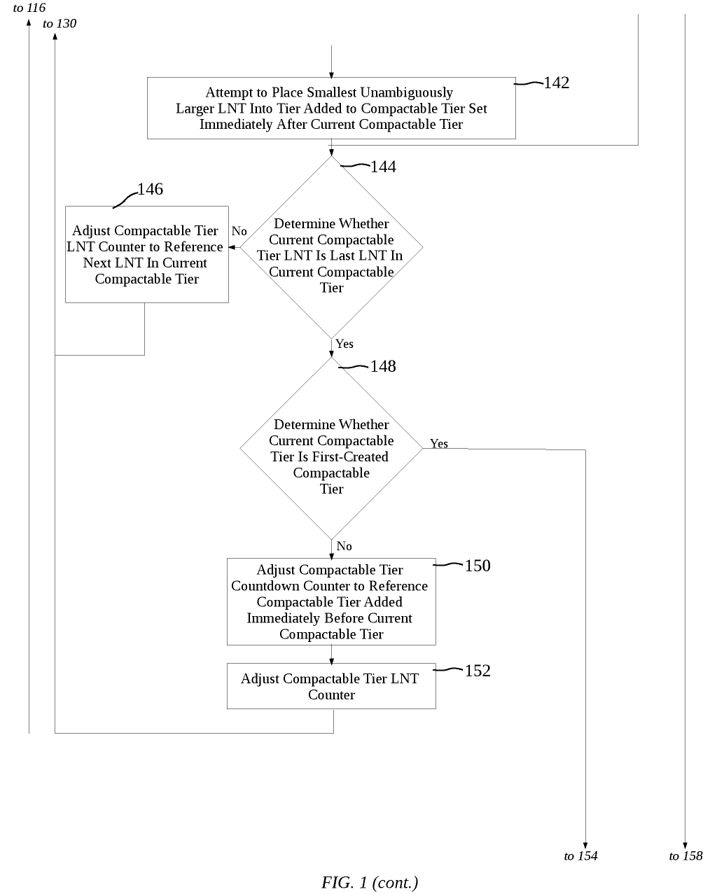

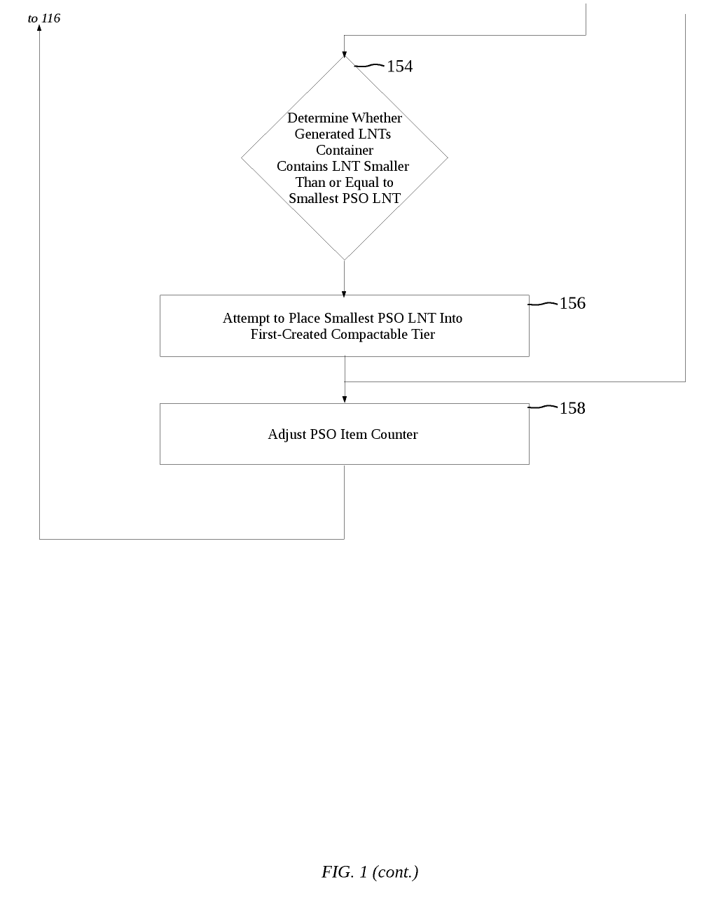

FIG. 1 is a flowchart illustrating a method 100 of inductively populating a compactable tier set.

FIG. 1 shows that the method 100 can include obtaining 102 two or more component sequences.

FIG. 1 shows that the method 100 can also include designating 104 one of the sequences as the primary sort-order sequence.

FIG. 1 shows that the method 100 can also include populating 106 a locations index for one or more component sequences other than the primary sort-order component sequence.

FIG. 1 shows that the method 100 can also include adding 108 each locations index to a locations index set.

FIG. 1 shows that the method 100 can also include creating 110 and initializing a primary sort-order item counter.

FIG. 1 shows that the method 100 can also include creating 112 a compactable tier set.

FIG. 1 shows that the method 100 can also include creating 114 a generated location n-tuples container.

FIG. 1 shows that the method 100 can also include determining 116 whether each locations index in the locations index set contains an associated locations list associated with the value of the item in the primary sort-order component sequence that is referenced by the current value of the primary sort-order item counter (the “primary sort-order cursor item”).

FIG. 1 shows that the method 100 can also include generating 118 a smallest primary sort-order location n-tuple when each locations index in the locations index set contains an associated locations list associated with the primary sort-order cursor item. A “smallest primary sort-order location n-tuple” is a primary sort-order location n-tuple whose component values comprise the current value of the primary sort-order item counter, together with the first entry in each corresponding associated locations list.

For example, assume that the first sequence (index 0) is selected 104 as the primary sort-order sequence and that the current value of the primary sort-order item counter is 0. Assume also that is determined 116 that each locations index in the location index set contains an associated locations list associated with the primary sort-order cursor item and that these associated locations are as follows:

{{0, 5}, {0, 4}, {0, 2, 4, 5, 6}}
The following smallest primary sort-order location n-tuple will be generated 118:
{0, 0, 0, 0}

FIG. 1 shows that the method 100 can also include determining 120 whether the compactable tier set is empty.

FIG. 1 shows that the method 100 can also include creating 122 a new compactable tier, adding the smallest primary sort-order location n-tuple to the newly-created compactable tier and adding the newly-created compactable tier to the compactable tier set when the compactable tier set is empty.

FIG. 1 shows that the method 100 can also include emptying 124 the generated location n-tuples container when the compactable tier set is not empty. To “empty” a container means to clear, reset, re-allocate or otherwise modify the container such that it no longer contains or references any data.

FIG. 1 shows that the method 100 can also include creating 126 a tier counter (the “compactable tier countdown counter”) and initializing it so that it references the most recently created compactable tier in the compactable tier set. A “tier counter” is a combination of computer storage capable of storing a reference to a particular tier within a tier set (which can include a compactable tier within a compactable tier set). Such a tier counter may be initialized so that it references a particular tier within the tier set and may thereafter be adjusted so that it references another tier that was added to the tier set either before or after the initially-referenced tier. To “reference” a tier means to uniquely and specifically identify the tier within the tier set (which can include use of a count, offset value or pointer).

FIG. 1 shows that the method 100 can also include creating 128 a location n-tuple counter (the “compactable tier location n-tuple counter”) and initializing it so that it references the first location n-tuple in the compactable tier referenced by the current value of the compactable tier countdown counter (the “current compactable tier”). A “location n-tuple counter” means a combination of computer storage capable of storing a reference to a location n-tuple within a group of location n-tuples (which can include a group of location n-tuples in a sequence or a group of location n-tuples in a tier). Such a location n-tuple counter may be initialized so that it references a particular location n-tuple within the group and may thereafter be adjusted so that it references a different location n-tuple within the group. To “reference” a location n-tuple means to uniquely and specifically identify the location n-tuple within a group of location n-tuples (which can include use of a count, offset value or pointer).

FIG. 1 shows that the method 100 can also include attempting 130 to generate a smallest unambiguously larger primary sort-order location n-tuple with respect to the location n-tuple referenced by the current value of the compactable tier location n-tuple counter (the “current compactable tier current location n-tuple”). A “smallest unambiguously larger primary sort-order location n-tuple” with respect to a location n-tuple is a primary sort-order location n-tuple whose component values comprise the current value of the primary sort-order item counter, together with the first entry in each associated locations list that is larger than the corresponding component value in the location n-tuple.

For example, assume that the current compactable tier current location n-tuple is as follows: {0, 0, 0, 0}. Assume also that the primary sort-order component value is the first component value (index 0) and that the current value of the primary sort-order counter is 1. Assume also that it was determined 116 that each locations index in the location index set contains an associated locations list as follows:

{{0, 5}, {0, 4}, {0, 2, 4, 5, 6}}
The following smallest unambiguously larger primary sort-order location n-tuple can be generated: {1, 5, 4, 2}.

Now assume the same premises except that the current compactable tier current location n-tuple is as follows: {0, 0, 7, 0}. Under these circumstances, no smallest unambiguously larger primary sort-order location n-tuple can be generated. Specifically, the third component value (index 2) in {0, 0, 7, 0} is larger than the largest value in the corresponding associated locations list (4).

For purposes of populating the compactable tier set, it is unnecessary to generate any location n-tuples with respect to the current compactable tier current location n-tuple other than the smallest unambiguously larger primary sort-order location n-tuple because any other generated location n-tuple would necessarily be superfluous of the smallest unambiguously larger primary sort-order location n-tuple. See application Ser. No. 15/263,200 for further information regarding the definition of a “superfluous” location n-tuple.

For example, assume that the current compactable tier current location n-tuple is {x₀, x₁, . . . xₙ,} and that a smallest unambiguously larger primary sort-order location n-tuple {x₀′, x₁′, . . . xₙ′} was successfully generated at 130. Assume also that the primary sort-order component value is the first component value (index 0). By the definition of a smallest unambiguously larger primary sort-order location n-tuple, the component values x₁′, x₂′, . . . xₙ′, comprise the smallest set of corresponding entries in the associated locations lists such that x₁<x₁′, x₂<x₂′, . . . xₙ<xₙ′. Consequently, any other primary sort-order location n-tuple {x₀″, x₁″, . . . xₙ″} that could be generated with respect to {x₀, x₁, . . . xₙ,} must necessarily satisfy the relationships that x₀′=x₀″ and x₁′≤x₁″, x₂′≤x₂″, . . . xₙ′≤xₙ″.

After it is generated, {x₀′, x₁′, . . . xₙ′} will either be placed into the compactable tier set or it will not be. If {(x₀′, x₁′, . . . xₙ′} is placed into the compactable tier set, it will be placed into the compactable tier that was created immediately after the current compactable tier at either 140 (if the current compactable tier is the most recently created compactable tier in the compactable tier set such that placement of {x₀′, x₁′, . . . xₙ′} necessitates creation of a new compactable tier) or 142 (if the current compactable tier is not the most recently created compactable tier in the compactable tier set).

Assuming that the current compactable tier is compactable tier[m], the target of the attempt to place {x₀′, x₁′, . . . xₙ′} will be compactable tier[m+1]. If {x₀′, x₁′, . . . xₙ′} is placed into compactable tier[m+1], it will (once placed) constitute an existing smaller or equal location n-tuple with respect to {x₀″, x₁″, . . . xₙ″}. Alternatively, if {x₀′, x₁′, . . . xₙ′} is not placed into tier[m+1], this means that tier[m+1] already contains an existing smaller or equal location n-tuple with respect to {x₀′, x₁′, . . . xₙ′}. In either event, any attempt to also place {x₀″, x₁″, . . . xₙ″} into compactable tier[m+1] will result in an inevitable omission compaction. Consequently, there is no need to generate {x₀″, x₁″, . . . xₙ″} in the first instance.

FIG. 1 shows that the method 100 can also include determining 132 whether a smallest unambiguously larger primary sort-order location n-tuple was generated.

FIG. 1 shows that the method 100 can also include determining 134 whether the generated location n-tuples container contains a location n-tuple that is smaller than or equal to the smallest unambiguously larger primary sort-order location n-tuple when a smallest unambiguously larger primary sort-order location n-tuple was generated. If this condition is satisfied, it means that an attempt has already been made to place a location n-tuple that is smaller than or equal to the smallest unambiguously larger primary sort-order location n-tuple into a compactable tier that was created more recently than the current compactable tier. Therefore, any further attempt to place the smallest unambiguously larger primary sort-order location n-tuple is unnecessary.

For example, assume that a smallest unambiguously larger primary sort-order location n-tuple {x₀′, x₁′, . . . xₙ′} was successfully generated at 130 and that the current compactable tier is compactable tier[m]. Assume also that the generated location n-tuples container contains a location n-tuple {x₀, x₁, . . . xₙ,} such that {x₀, x₁, . . . xₙ}≤{x₀′, x₁′, . . . xₙ′}. This means that an attempt was already made to place {x₀, x₁, . . . xₙ} into compactable tier[m+1+y] where y≥0. Hence, there is no need to attempt to place {(x₀′, x₁′, . . . xₙ′} into compactable tier[m+1], for the following reason.

Location n-tuple {x₀′, x₁′, . . . xₙ′} is not relevant to the placement of a subsequent location n-tuple {x₀″, x₁″, . . . xₙ″} unless both of the following conditions are met: (i) {x₀′, x₁′, . . . xₙ′} is unambiguously smaller than {x₀″, x₁″, . . . xₙ″}; and (ii) {x₀′, x₁′, . . . xₙ′} is contained in the most recently created compactable tier among the set of compactable tiers containing a location n-tuple that is unambiguously smaller than {x₀″, x₁″, . . . xₙ″}. The presence of {x₀, x₁, . . . xₙ,} in the generated location n-tuples container means that an attempt was already made to place {x₀, x₁, . . . xₙ,} into compactable tier[m+1+y] where y≥0. Either this attempt was successful or it was not.

If successful, then either compactable tier[m+1] (when y=0) or a more recently created compactable tier (when y>0) already contains {x₀, x₁, . . . xₙ}. Because {x₀, x₁, . . . xₙ}≤{x₀′, x₁′, . . . xₙ′}<{x₀″, x₁″, . . . xₙ″}⇒{x₀, x₁, . . . xₙ}<{x₀″, x₁″, . . . xₙ″}, placing {(x₀′, x₁′, . . . xₙ′} into compactable tier[m+1] cannot satisfy condition (ii) because either compactable tier[m+1] already contains another location n-tuple {(x₀, x₁, . . . xₙ,} that is unambiguously smaller than {(x₀″, x₁″, . . . xₙ″} (such that also placing {(x₀′, x₁′, . . . xₙ′} into compactable tier[m+1] would be redundant) or compactable tier[m+1] is not the most recently created compactable tier among the set of compactable tiers containing a location n-tuple that is unambiguously smaller than {x₀″, x₁″, . . . xₙ″}.

Alternatively, the attempt to place {(x₀, x₁, . . . xₙ,} into a more recently created compactable tier might have failed. If so, this means that compactable tier[m+1+y] where y≥0 contains an existing smaller or equal location n-tuple {x₀″′, x₁′″, . . . xₙ″′} with respect to {(x₀, x₁, . . . xₙ,}. Because {(x₀″′, x₁″′, . . . xₙ″′}≤{x₀, x₁, . . . xₙ}≤{x₀′, x₁′, . . . xₙ′}<{x₀″, x₁″, . . . xₙ″}⇒{x₀″′, x₁″′, . . . xₙ′″}≤{(x₀″, x₁″, . . . xₙ″},

placing {(x₀′, x₁′, . . . xₙ′} into compactable tier[m+1] cannot satisfy condition (ii) because either compactable tier[m+1] already contains a location n-tuple {x₀″′, x₁′″, . . . xₙ″′} that is unambiguously smaller than {x₀″, x₁″, . . . xₙ″}, (such that also placing {x₀′, x₁′, . . . xₙ′} into compactable tier[m+1] would be redundant) or compactable tier[m+1] is not the most recently created compactable tier among the set of compactable tiers containing a location n-tuple that is unambiguously smaller than {x₀″, x₁″, . . . xₙ″}.

FIG. 1 shows that the method 100 can also include adding 136 the smallest unambiguously larger primary sort-order location n-tuple to the generated location n-tuples container when the generated location n-tuples container does not contain a location n-tuple that is smaller than or equal to the smallest unambiguously larger primary sort-order location n-tuple.

FIG. 1 shows that the method 100 can also include determining 138 whether the current compactable tier is the most recently created compactable tier in the compactable tier set.

FIG. 1 shows that the method 100 can also include creating 140 a new compactable tier, adding the smallest unambiguously larger primary sort-order location n-tuple to the newly-created compactable tier and adding the newly-created compactable tier to the compactable tier set when the current compactable tier is the most recently created compactable tier in the compactable tier set.

FIG. 1 shows that the method 100 can also include attempting 142 to place the smallest unambiguously larger primary sort-order location n-tuple into the compactable tier that was added to the compactable tier set immediately after the current compactable tier when the current compactable tier is not the most recently created compactable tier in the compactable tier set.

FIG. 1 shows that the method 100 can also include determining 144 whether the current compactable tier current location n-tuple is the last location n-tuple in the current compactable tier.

FIG. 1 shows that the method 100 can also include adjusting 146 the compactable tier location n-tuple counter so that it references the next location n-tuple in the current compactable tier when the current compactable tier current location n-tuple is not the last location n-tuple in the current compactable tier.

FIG. 1 shows that the method 100 can also include determining 148 whether the current compactable tier is the first-created compactable tier in the compactable tier set when the current compactable tier current location n-tuple is the last location n-tuple in the current compactable tier.

FIG. 1 shows that the method 100 can also include adjusting 150 the compactable tier countdown counter so that it references the compactable tier that was added to compactable tier set immediately before the current compactable tier when the current compactable tier is not the first-created compactable tier in the compactable tier set.

FIG. 1 shows that the method 100 can also include adjusting 152 the compactable tier location n-tuple counter so that it references the first location n-tuple in the compactable tier referenced by the current value of the compactable tier countdown counter.

Steps 130-152 are repeated (as applicable) until it is determined 144 that the current compactable tier current location n-tuple is the last location n-tuple in the current compactable tier and it is determined 148 that the current compactable tier is the first-created compactable tier in the compactable tier set.

FIG. 1 shows that the method 100 can also include determining 154 whether the generated location n-tuples container contains a location n-tuple that is smaller than or equal to the smallest primary sort-order location n-tuple.

FIG. 1 shows that the method 100 can also include attempting 156 to place the smallest primary sort-order location n-tuple into the first-created compactable tier in the compactable tier set when the generated location n-tuples container does not contain a location n-tuple that is smaller than or equal to the smallest primary sort-order location n-tuple.

FIG. 1 shows that the method 100 can also include adjusting 158 the primary sort-order item counter.

Steps 116-158 may be repeated for each subsequent item in the primary sort-order sequence.

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Assume three component sequences, S1, S2 and S3 as follows:
S1: {A, X, C, A, D, F, H, I, Y, Z, J, K}
S2: {C, A, Y, D, H, F, I, X, Z, K, J, K}
S3: {A, D, C, Z, F, H, A, D, I, X, Y, J, K}

These same component sequences may alternately be depicted as follows:

| | | |
|---|---|---|
| S1[0] = A | S2[0] = C | S3[0] = A |
| S1[1] = X | S2[1] = A | S3[1] = D |
| S1[2] = C | S2[2] = Y | S3[2] = C |
| S1[3] = A | S2[3] = D | S3[3] = Z |
| S1[4] = D | S2[4] = H | S3[4] = F |
| S1[5] = F | S2[5] = F | S3[5] = H |
| S1[6] = H | S2[6] = I | S3[6] = A |
| S1[7] = I | S2[7] = X | S3[7] = D |
| S1[8] = Y | S2[8] = Z | S3[8] = I |
| S1[9] = Z | S2[9] = K | S3[9] = X |
| S1[10] = J | S2[10] = J | S3[10] = Y |
| S1[11] = K | S2[11] = K | S3[11] = J |
| | | S3[12] = K |

Assume that at 104, S1 is selected as the primary sort-order component sequence. After a location index is populated is populated 106 for S2 and S3 and each locations index is added 108 to the locations index set, the locations index set might be depicted as follows:

| Item | S2 Locations | S3 Locations |
|---|---|---|
| A | {1} | {0, 6} |
| X | {7} | {9} |
| C | {0} | {2} |
| D | {3} | {1, 7} |
| F | {5} | {4} |
| H | {4} | {5} |
| I | {6} | {8} |
| Y | {2} | {10} |
| Z | {8} | {3} |
| J | {10} | {11} |
| K | {9, 11} | {12} |

At 110, the primary sort-order item counter is created and initialized to some desired value (which is assumed for purposes of this example to be zero). A compactable tier set is created 112 and a generated location n-tuples container is created 114.

At the first iteration of 116, the first item in S1 (A) is the primary sort-order cursor item. It is determined 116 that each locations index in the locations index set contains an associated locations list associated with the primary sort-order cursor item, as follows:
S2 associated locations list: {1}
S3 associated locations list: {0, 6}

The following smallest primary sort-order location n-tuple is generated 118: {0, 1, 0}

Because it is determined 120 that the compactable tier set is empty, a new compactable tier is created 122, {0, 1, 0} is added to the newly-created compactable tier and the newly-created compactable tier is added to the compactable tier set. The compactable tier set might now be depicted as follows:
compactable tier 0: {{0, 1, 0}}

The primary sort-order item counter is thereafter adjusted 158 (which, for purposes of this example, is assumed to be accomplished by incrementing it such that it now equals one). At the next iteration of 116, the second item in S1 (X) is the primary sort-order cursor item.

It is determined 116 that each locations index in the locations index set contains an associated locations list associated with the primary sort-order cursor item, as follows:
S2 associated locations list: {7}
S3 associated locations list: {9}

The following smallest primary sort-order location n-tuple is generated 118: {1, 7, 9}

Because it is determined 120 that the compactable tier set is not empty, the generated location n-tuples container is emptied 124. The compactable tier countdown counter is created 126 and initialized to reference compactable tier 0. The compactable tier location n-tuple counter is created 128 and initialized to reference the first location n-tuple in compactable tier 0: {0, 1, 0}

An attempt 130 is made to generate a smallest unambiguously larger primary sort-order location n-tuple with respect to {0, 1, 0}. The attempt succeeds and the following smallest unambiguously larger primary sort-order location n-tuple is generated: {1, 7, 9}

Because it is determined 132 that a smallest unambiguously larger primary sort-order location n-tuple was generated, the generated location n-tuples container is examined to determine 134 whether it contains a location n-tuple that is smaller than or equal to {1, 7, 9}. Because it is determined 134 that the generated location n-tuples container does not contain a location n-tuple that is smaller than or equal to {1, 7, 9}, {1, 7, 9} is added 136 to the generated location n-tuples container.

Because it is determined 138 that the current compactable tier is the most recently created compactable tier in the compactable tier set, a new compactable tier is created 140, {1, 7, 9} is added to the newly-created compactable tier and the newly-created compactable tier is added to the compactable tier set. The compactable tier set might now be depicted as follows:
compactable tier 0: {{0, 1, 0}}
compactable tier 1: {{1, 7, 9}}

Because it is determined 144 that the current compactable tier current location n-tuple is the last location n-tuple in the current compactable tier and it is determined 148 that the current compactable tier is the first-created compactable tier in the compactable tier set, processing proceeds to step 154.

Because it is determined 154 that the generated location n-tuples container contains a location n-tuple ({1, 7, 9}) that is smaller than or equal to the smallest primary sort-order location n-tuple ({1, 7, 9}), no attempt is made to place {1, 7, 9} into compactable tier 0. (It is necessarily always that case that a location n-tuple is smaller than or equal to itself).

The primary sort-order item counter is thereafter adjusted 158 (which, for purposes of this example, is assumed to be accomplished by incrementing it such that it now equals two). At the next Iteration of 116, the third item in S1 (C) is the primary sort-order cursor item.

It is determined 116 that each locations index in the locations index set contains an associated locations list associated with the primary sort-order cursor item, as follows:
S2 associated locations list: {0}
S3 associated locations list: {2}

The following smallest primary sort-order location n-tuple is generated 118 from these associated locations lists: {2, 0, 2}

Because it is determined 120 that the compactable tier set is not empty, the generated location n-tuples container is emptied 124. The compactable tier countdown counter is created 126 and initialized to reference compactable tier 1. The compactable tier location n-tuple counter is created 128 and initialized to reference the first location n-tuple in compactable tier 1: {1, 7, 9}

An attempt 130 is made to generate a smallest unambiguously larger primary sort-order location n-tuple with respect to {1, 7, 9}. The attempt fails because neither of the associated locations lists for S2 or S3 contain entries that are larger than the second and third component values (indexes 1 and 2, respectively) of {1, 7, 9}.

Because it is determined 132 that no smallest unambiguously larger primary sort-order location n-tuple was generated, processing proceeds to 144.

Because it is determined 144 that the current compactable tier current location n-tuple is the last location n-tuple in the current compactable tier and it is determined 148 that the current compactable tier is not the first-created compactable tier in the compactable tier set, the compactable tier countdown counter is adjusted 150 so that it references compactable tier 0 and the current tier location n-tuple counter is adjusted 152 so that it references the first location n-tuple in compactable tier 0: {0, 1, 0}

An attempt 130 is made to generate a smallest unambiguously larger primary sort-order location n-tuple with respect to {0, 1, 0}. The attempt fails because the associated locations list for S2 does not contain an entry that is larger than the second component value (index 1) of {0, 1, 0}.

Because it is determined 132 that no smallest unambiguously larger primary sort-order location n-tuple was generated, processing proceeds to 144.

Because it is determined 144 that the current compactable tier current location n-tuple is the last location n-tuple in the current compactable tier and it is determined 148 that the current compactable tier is the first-created compactable tier in the compactable tier set, processing proceeds to 154.

Because it is determined 154 that that generated location n-tuples container does not contain a location n-tuple that is smaller than or equal to the smallest primary sort-order location n-tuple ({2, 0, 2}), an attempt 156 is made to place {2, 0, 2} into compactable tier 0. The attempt succeeds and the compactable tier might now be depicted as follows:
compactable tier 0: {{0, 1, 0}, {2, 0, 2}}
compactable tier 1: {{1, 7, 9}}

The primary sort-order item counter is thereafter adjusted 158 (which, for purposes of this example, is assumed to be accomplished by incrementing it such that it now equals three). At the next iteration of 116, the fourth item in S1 (A) is the primary sort-order cursor item.

It is determined 116 that each locations index in the locations index set contains an associated locations list associated with the primary sort-order cursor item, as follows:
S2 associated locations list: {1}
S3 associated locations list: {0, 6}

The following smallest primary sort-order location n-tuple is generated 118 from these associated locations lists: {3, 1, 0}

Because it is determined 120 that the compactable tier set is not empty, the generated location n-tuples container is emptied 124. The compactable tier countdown counter is created 126 and initialized to reference compactable tier 1. The compactable tier location n-tuple counter is created 128 and initialized to reference the first location n-tuple in compactable tier 1: {1, 7, 9}

An attempt 130 is made to generate a smallest unambiguously larger primary sort-order location n-tuple with respect to {1, 7, 9}. The attempt fails because neither of the associated locations lists for S2 or S3 contain entries that are larger than the second and third component values (indexes 1 and 2, respectively) of {1, 7, 9}.

Because it is determined 132 that no smallest unambiguously larger primary sort-order location n-tuple was generated, processing proceeds to 144.

Because it is determined 144 that the current compactable tier current location n-tuple is the last location n-tuple in the current compactable tier and it is determined 148 that the current compactable tier is not the first-created compactable tier in the compactable tier set, the compactable tier countdown counter is adjusted 150 so that it references compactable tier 0 and the current tier location n-tuple counter is adjusted 152 so that it references the first location n-tuple in compactable tier 0: {0, 1, 0}

An attempt 130 is made to generate a smallest unambiguously larger primary sort-order location n-tuple with respect to {0, 1, 0}. The attempt fails because the associated locations lists for S2 does not contain an entry that is larger than the second component value (index 1) of {0, 1, 0}.

Because it is determined 144 that the current compactable tier current location n-tuple is not the last location n-tuple in the current compactable tier, the compactable tier location n-tuple counter is adjusted 146 so that it references the next location n-tuple in the current compactable tier: {2, 0, 2}

An attempt 130 is made to generate a smallest unambiguously larger primary sort-order location n-tuple with respect to {2, 0, 2}. The attempt succeeds and the following smallest unambiguously larger primary sort-order location n-tuple is generated: {3, 1, 6}

Because it is determined 132 that a smallest unambiguously larger primary sort-order location n-tuple was generated, the generated location n-tuples container is examined to determine 134 whether it contains a location n-tuple that is smaller than or equal to {3, 1, 6}. Because it is determined 134 that the generated location n-tuples container does not contain a location n-tuple that is smaller than or equal to {3, 1, 6}, {3, 1, 6} is added 136 to the generated location n-tuples container.

Because it is determined 138 that the current compactable tier is not the most recently created compactable tier in the compactable tier set, an attempt 142 is made to place {3, 1, 6} into compactable tier 1. The attempt succeeds and the compactable tier set might now be depicted as follows:
compactable tier 0: {{0, 1, 0}, {2, 0, 2}}
compactable tier 1: {{1, 7, 9}, {3, 1, 6}}

Because it is determined 144 that the current compactable tier current location n-tuple is the last location n-tuple in the current compactable tier and it is determined 148 that the current compactable tier is the first-created compactable tier in the compactable tier set, processing proceeds to 154.

Because it is determined 154 that the generated location n-tuples container does not contain a location n-tuple that is smaller than or equal to the smallest primary sort-order location n-tuple ({3, 1, 0}), an attempt 156 is made to place {3, 1, 0} into compactable tier 0. The attempt fails due to an omission compaction because compactable tier 0 contains an existing smaller or equal location n-tuple: {0, 1, 0}

Addition iterations of steps 116-158 are not illustrated for purposes of this example.

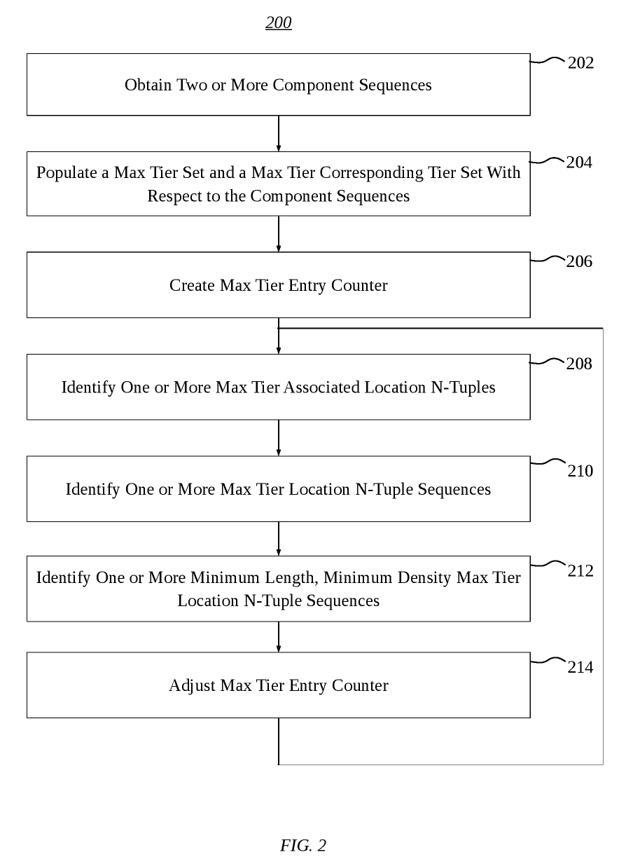

FIG. 2 is a flowchart illustrating a method 200 of tentatively establishing or ruling out the existence of certain minimum length, minimum density common subsequences (or “MLMD common sequences”) among two or more component sequences.

FIG. 2 shows that the method 200 can include obtaining 202 two or more component sequences.

FIG. 2 shows that the method 200 can also include populating 204 a max tier set and a max tier corresponding tier set with respect to the component sequences.

FIG. 2 shows that the method 200 can also include creating 206 a counter (the “max tier entry counter”) and initializing it to reference one of the entries in the max tier set.

FIG. 2 shows that the method 200 can also include identifying 208 one or more location n-tuples in the max tier corresponding tier set that are associated with the entry in the max tier set referenced by the current value of the max tier entry counter (each a “max tier associated location n-tuple”). A location n-tuple in a max tier corresponding tier set is associated with an entry in a max tier set if and only if: (i) the component value in the location n-tuple that corresponds to the max tier component value is equal to the value of the entry in the max tier set; and (ii) the ordinal value of the tier containing the location n-tuple is equal to the ordinal value of the max tier containing the entry.

By way of example, consider the following max tier corresponding tier set:

tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Assuming that the first component value is the max component value, the following max tier set may be generated from the max tier corresponding tier set:

max tier 0: {0, 2}
max tier 1: {1, 3}
max tier 2: {4, 5, 6, 8, 9}
max tier 3: {7}
max tier 4: {10}
max tier 5: {11}

The entry in max tier 5 (11) is associated with the location n-tuple in tier 5 ({11, 11, 12}). Thus, {11, 11, 12} is a max tier associated location n-tuple.

By contrast this entry is not associated with the second location n-tuple contained in tier 4 ({11, 9, 12}). Although the first component value of {11, 9, 12} is equal to the value of the entry in max tier 5 (such that condition (i) is satisfied), the ordinal value of the max tier containing {11} is 5, whereas the ordinal value of the tier containing {11, 9, 12} is 4 (and hence condition (ii) is not satisfied). Thus, {11, 9, 12} is not a max tier associated location n-tuple.

FIG. 2 shows that the method 200 can also include identifying 210 one or more permutations that may be generated by selecting the max tier associated location n-tuple from the tier in the max tier corresponding tier set that contains the max tier associated location n-tuple, together with precisely one location n-tuple from zero or more of the tiers that were added to the max tier corresponding tier set before the tier containing the max tier associated location n-tuple, such that the set of selected location n-tuples satisfies the increasing order requirement (each a “max tier location n-tuple sequence”).

FIG. 2 shows that the method 200 can also include identifying 212 the subset of identified 210 max tier location n-tuple sequences that satisfy a minimum length requirement and a minimum density requirement with respect to the max component value (each a “minimum length, minimum density max tier location n-tuple sequence”).

The process of identifying 212 one or more minimum length, minimum density max tier location n-tuple sequences can be used as a screening test to rule out the existence of a minimum length, minimum density location n-tuple sequence among the location n-tuples in the max tier corresponding tier set. A “minimum length, minimum density location n-tuple sequence” means a sequence of location n-tuples in increasing order that satisfy a requirement as to minimum length and minimum density.

The existence of a minimum length, minimum density location n-tuple sequence within a tier set presupposes and requires the existence of at least one minimum length, minimum density max tier location n-tuple sequence of the same or greater length and density with respect to each of the component values comprising the location n-tuples in the tier set. Conversely, the failure to identify at least one minimum length, minimum density max tier location n-tuple sequence with respect to each of the component values comprising the location n-tuples in the tier set precludes the existence of a minimum length, minimum density location n-tuple sequence of the same or greater length and density within the tier set (the “max tier screening property”).

The max tier screening property also applies in the more specific case of a pair of tiers in the max tier corresponding tier set (comprising a “lower tier” and an “upper tier”). The failure to identify at least one minimum length, minimum density max tier location n-tuple sequence with respect to each of the component values comprising the location n-tuples in the upper and lower tiers precludes the existence of a minimum length, minimum density location n-tuple sequence of the same or greater length and density between the upper and lower tiers (the “max tier pairwise screening property”).

For example, consider the following tier set:

tier 0: {{0, 1, 3}, {1, 0, 0}, {1, 0, 1}, {1, 0, 2}, {1, 2, 0}, {1, 2, 1}, {1, 2, 2}, {1, 3, 0}, {1, 3, 1}, {1, 3, 2}, {2, 0, 0}, {2, 0, 1}, {2, 0, 2}, {2, 2, 0}, {2, 3, 0}, {3, 0, 0}, {3, 0, 1}, {3, 0, 2}, {3, 2, 0}, {3, 3, 0}}
tier 1: {{2, 2, 1}, {2, 2, 2}, {2, 3, 1}, {2, 3, 2}, {3, 2, 1}, {3, 2, 2}, {3, 3, 1}}
tier 2: {{3, 3, 2}}

Assuming that the first component value is the max component value, the following max tier set may be generated from the max tier corresponding tier set:

max tier 0: {0, 1}
max tier 1: {2}
max tier 2: {3}

Assuming that the second component value is the max component value, the following max tier set may be generated from the max tier corresponding tier set:

max tier 0: {0, 1}
max tier 1: {2}
max tier 2: {3}

Assuming that the third component value is the max component value, the following max tier set may be generated from the max tier corresponding tier set:

max tier 0: {0, 3}
max tier 1: {1}
max tier 2: {2}

Now assume that a minimum length requirement of 2 is imposed and a minimum density requirement of 1.0 is imposed. The possible existence of one or more minimum length, minimum density common subsequences satisfying these requirements can be tentatively established (but not positively confirmed) if one or more minimum length, minimum density max tier location n-tuple sequences can be identified.

Considering first the minimum length requirement, we see that the following combinations of tiers can yield common subsequences of length 2 or greater, with each tier contributing precisely one location n-tuple: (i) tier 0 and tier 1, (ii) tier 1 and tier 2, and (iii) tier 0, tier 1 and tier 2. Note that although the combination of tier 0 and tier 2 could also potentially yield a common subsequence of length 2, this combination is subsumed within combination (iii) above, the combination of tier 0, tier 1 and tier 2. Hence, it is unnecessary to separately inspect the combination of tier 0 and tier 2 because both the length and density of any combination of location n-tuples selected respectively from tier 0, tier 1 and tier 2 must necessarily exceed that of a comparable combination of location n-tuples selected only from tier 0 and tier 2 respectively. More generally, it is always the case that the length and density of any combination of location n-tuples selected respectively from any number of contiguous tiers necessarily equal or exceed that of a comparable combination of location n-tuples selected from the same number of non-contiguous tiers. This is referred to herein as the “tier contiguity principle.”

Examining first the minimum length, minimum density max tier location n-tuple sequences that may be identified by selecting precisely one location n-tuple from each of tier 0 and tier 1, we note that the potential max tier screening property limits the number of location n-tuples that we must examine in tier 1. Considering first the first component value, we note that we need only examine those location n-tuples in tier 1 that have a first component value of 2 (i.e. {2, 2, 1}, {2, 2, 2}, {2, 3, 1}, {2, 3, 2}) because these are the only location n-tuples in tier 1 that are max tier associated location n-tuple with respect to the first component value. Thus, we need not consider location n-tuples {3, 2, 1}, {3, 2, 2} or {3, 3, 1} because another tier (tier 2) contains a location n-tuple ({3, 3, 2}) with the same first component value (3) that is a max tier associated location n-tuple.

The latter set of location n-tuples may be ignored in an attempt to identify 212 one or more minimum length, minimum density max tier location n-tuple sequences in the first component value because of the nature of a max tier set. Specifically, a max tier set maximizes density with respect to the max tier component value. By the definition of a max tier set, each max tier component value in each max tier references the most recently created tier in the max tier corresponding tier set that contains a location n-tuple with an applicable component value equal to the max tier component value. This in turn maximizes the number of tiers in the max tier corresponding tier set that contain location n-tuples with an applicable component value less than the max tier component value in the max tier associated location n-tuple and thus the density with respect to the max tier component value of any max tier location n-tuple sequence containing the max tier associated location n-tuple due to the tier contiguity principle (as the same applies in one dimension—i.e. to only the max tier component value rather than all of the component values).

Considering first the first component value, we note that {2, 2, 1}, {2, 2, 2}, {2, 3, 1} and {2, 3, 2} each satisfy the minimum density requirement with respect to the first component value because of the presence of {1, 0, 0} in tier 0.

Considering next the second component value, we note that no minimum length, minimum density max tier location n-tuple sequence can be identified that includes {2, 2, 1}, {2, 2, 2}, {3, 2, 1} or {3, 2, 2}. Thus, we have ruled out the possible existence of a minimum length, minimum density tier location n-tuple sequence between tier 1 and tier 0. Because of the max tier pairwise screening property, we need not further consider this combination of tiers.

Examining next the minimum length, minimum density max tier location n-tuple sequences that may be identified by selecting precisely one location n-tuple from each of tier 1 and tier 2, we note that the single location n-tuple contained therein ({3, 3, 2}) satisfies the max tier screening property with respect to all three component values because of the presence of {2, 2, 1} in tier 1. We have thus tentatively established the existence of a minimum length, minimum density tier location n-tuple sequence of at least length 2 and density 1.0 between tier 2 and tier 1.

FIG. 2 shows that the method 200 can also include adjusting 206 the max tier entry counter so that it reference a different entry in the max tier set

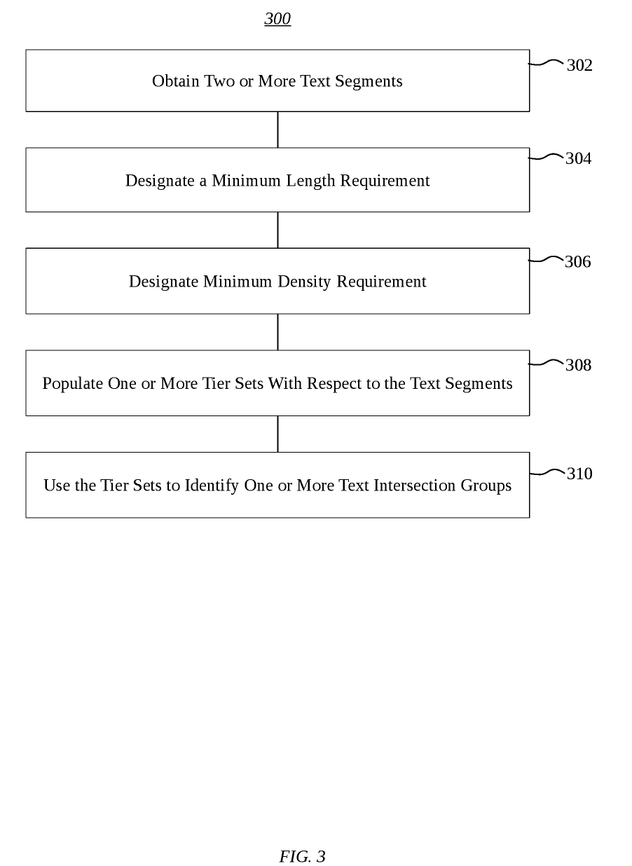

FIG. 3 is a flowchart illustrating a method 300 of locating one or more text intersection groups among two or more text segments. A “text intersection group” between or among two or more text segments means text that occurs: (i) in each of the text segments; (ii) in the same order in each text segment; and (iii) within a region in each that satisfies requirements as to minimum length and/or minimum density. A “text segment” means any document or other sequence of text, either complete in itself or excerpted from a larger document or other sequence of text. Consider the following example text segments:

| Text Segment 1 | Text Segment 2 | Text Segment 3 |
|---|---|---|
| Our story starts on a | Our tale begins on a dark | This tale commences |
| dark and stormy night | and stormy night not | on a dark and stormy |
| many years ago, in an | many years ago, in a | night not long ago, |
| unremarkable house on | nondescript house on an | in a foreboding |
| an unremarkable street | average street in an | house on a dreary |
| in an unremarkable | unremarkable city. | street in a |
| city. | | forgotten city. |

If the text satisfying criteria (i) and (ii) (referred to as “overlapping text”) is marked using boldface, the text segments might now be depicted as follows:

| Text Segment 1 | Text Segment 2 | Text Segment 3 |
|---|---|---|
| Our story starts on a | Our tale begins on a | This tale commences |
| dark and stormy night | dark and stormy | on a dark and |
| many years ago, in | night not many years | stormy night not |
| an unremarkable house | ago, in a nondescript | long ago, in a |
| on an unremarkable | house on an average | foreboding house on |
| street in an | street in an | a dreary street in a |
| unremarkable city. | unremarkable city. | forgotten city. |

Regarding criteria (iii), note that the density of the overlapping text in text segment 1 is equal to 13/21=˜0.62. This is because the overlapping text, which comprises 13 words, is interspersed in text segment 1 with 8 words that do not overlap: “many years” and “an unremarkable” (with three consecutive occurrences of the latter). The density of the overlapping text in text segment 3 is also equal to 13/21=˜0.62. The density of the overlapping text in text segment 2, however, is equal to 13/22=˜0.59. This is because the overlapping text, which comprises 13 words, is interspersed in text segment 2 with 9 words that do not overlap: “not many years,” “a nondescript,” “an average,” and “an unremarkable.” For purposes of this example, the word level is used as the level of granularity for determining density. However, any desired level of granularity (including the individual letter or character level) may be employed.

If a minimum density requirement of 0.60 is imposed, the overlapping text does not constitute a global text intersection group among text segment 1, text segment 2 and text segment 3 because the minimum density requirement is not satisfied as to all text segments. However, the overlapping text would constitute a pairwise text intersection group as between text segment 1 and text segment 3 because the minimum density requirement is satisfied as to both.

FIG. 3 shows that the method 300 can include obtaining 302 two or more text segments.

FIG. 3 shows that the method 300 can also include designating 304 a minimum length requirement.

FIG. 3 shows that the method 300 can also include designating 306 a minimum density requirement.

FIG. 3 shows that the method 300 can also include populating 308 one or more tier sets with respect to the text segments.

FIG. 3 shows that the method 300 can also include using 310 the tier sets to identify one or more text intersection groups with respect to two or more of the text segments. Using 310 the tier sets to identify one or more text intersection groups with respect to two or more of the text segments can comprise multiple different approaches, which can include identifying one or more global text intersection group among all of the text segments as in the previous example. It can also include serial pairwise comparisons between a source text segment and one or more target text segments to identify one or more pairwise text intersection groups. A “source text segment” means a text segment that is designated as a text segment against which one or more target text segments will be compared in an attempt to identify one or more text intersection groups. A “target text segment” means a text segment that will be compared to a source text segment.

One application of such a pairwise approach is a search engine that takes an entire text segment (the source text segment) as a search term and searches on each and every word, character or other constituent part thereof by serially comparing the source text segment to one or more target text segments to identify one or more text intersection groups. Considering again the prior example, assume that text segment 1 is designated as the source text segment, that a minimum length requirement of 13 is designated 304 and a minimum density requirement of 0.6 is designated 306. Assume that text segment 2 and text segment 3 are successively designated as target text segments.

No text intersection group is identified between text segment 1 and text segment 2 because although the minimum length requirement is satisfied, as noted supra, the minimum density requirement is not satisfied. (If, however, a minimum length requirement of 6 rather than 13 had been designated 304, a text intersection group of density 1.0 would exist between text segment 1 and text segment 2 comprising the text “on a dark and stormy night”).

By contrast, a text intersection group with density (at the word level of granularity) of 13/21˜=0.62 is identified between text segment 1 and text segment 3 comprising the text “on a dark and stormy night . . . ago, in . . . house on . . . street in . . . city.”

This illustrates one potential use of such a pairwise comparison approach —automated identification of near-duplicate text segments using objectively verifiable relatedness criteria (“TIG near-duplicate identification”). TIG near-duplicate identification offers benefits lacking in other pre-existing approaches.

TIG near-duplicate identification outperforms hash algorithms because even slight differences between text segments will yield vastly different hash values. Thus, hash algorithms are generally useful only for identifying exact duplicate text segments. By contrast, TIG near-duplicate identification can identify any degree of relatedness (as measured by the length and density requirements) up to and including exact duplication.

TIG near-duplicate identification outperforms keyword search because the latter is generally incapable of searching on all of the words (or other constituent components) of a source text segment of greater than trivial length. Also, keyword searching on certain commonly-occurring words such as “the” or “an” is often prohibitive in terms of computational resources (and such functionality is consequently omitted from many search engines). Furthermore, keyword search necessarily requires the user to supply in advance the keywords to be used as search terms (by designating them as “key” words). In contrast, TIG near-duplicate identification can search using all of the words (or other constituent components) of the source text segment (including such commonly-occurring ones as “the” or “an”) without requiring a user to identify particular ones in advance.

TIG near-duplicate identification outperforms statistical comparison algorithms because its results are deterministic rather than probabilistic. Statistical comparison algorithms (including variations of the types of “recommendation engines” employed by many online retailers) generally promise only to identify target text segments that are statistically likely (but not always guaranteed) to be related to the source text segment. Thus, at least some related target text segments may be missed. At the same time, statistical algorithms may also return some false positives (i.e. text segments that the algorithm mistakenly identifies as related). By contrast, TIG near-duplicate identification is deterministic, meaning that, given a source text segment and minimum length and density requirements, it is guaranteed to identify the complete set of target text segments containing one or more text intersection groups in common with the source text segment.

TIG near-duplicate identification outperforms proprietary comparison algorithms because the results of the latter may not be objectively verifiable. Rather, the precise criteria used by a particular algorithm may be regarded as a proprietary trade secret and not disclosable. Thus, the end user may be unable to objectively verify the results of the algorithm but instead have to rely upon generalized trust in the algorithm based upon prior use or testimonials from other users. In contrast, TIG near-duplicate identification provides objectively verifiable results. That is, a user may confirm by visual inspection that a source text segment and a target text share one or more text intersection groups of at least the minimum length and at least the minimum density.

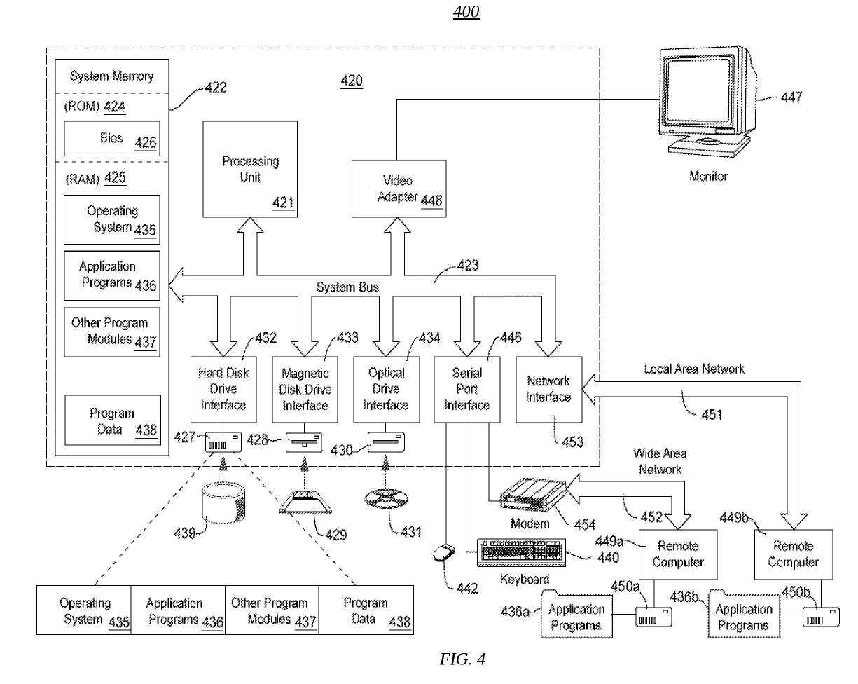

FIG. 4, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of inductively populating a compactable tier set, the method comprising:
obtaining two or more component sequences;
designating one of the component sequences as the primary sort-order component sequence;
populating a locations index for at least one component sequence other than the primary sort-order component sequence;
adding each location index to a location index set;
creating a compactable tier set;
creating a generated location n-tuples container; and
creating and initializing a primary sort-order item counter.

2. The method of claim 1, further comprising:
when each locations index in the locations index set contains a locations list associated with the value of the primary sort-order cursor item:
generating a smallest primary sort-order location n-tuple.

3. The method of claim 2, further comprising:
when the compactable tier set is empty:
creating a new compactable tier, placing the smallest primary sort-order location n-tuple into the newly-created tier and adding the newly-created compactable tier to the compactable tier set.

4. The method of claim 2, further comprising:
when the compactable tier set is not empty:
generating and attempting to place one or more smallest unambiguously larger primary sort-order location n-tuples with respect to the location n-tuples contained in the compactable tier set.

5. The method of claim 4, further comprising:
when the generated location n-tuples container does not contain a location n-tuple that is smaller than or equal to the smallest primary sort-order location n-tuple:
attempting to place the smallest primary sort-order location n-tuple into the first-created compactable tier in the compactable tier.

6. The method of claim 2, further comprising:
adjusting the primary sort-order item counter.

7. The method of claim 4, wherein generating and attempting to place one or more smallest unambiguously larger primary sort-order location n-tuples with respect to the location n-tuples contained in the compactable tier set includes:
emptying the generated location n-tuples container; and
creating a compactable tier countdown counter and initializing it so that it references the most recently created compactable tier.

8. The method of claim 7, further comprising:
creating a compactable tier location n-tuple counter.

9. The method of claim 8, further comprising:
attempting to generate a smallest unambiguously larger location with respect to the current compactable tier current location n-tuple.

10. The method of claim 9, further comprising:
when the attempt to generate a smallest unambiguously larger primary sort-order location n-tuple with respect to the current compactable tier current location n-tuple succeeds and the generated location n-tuples container does not contain a location n-tuple that is smaller than or equal to the smallest unambiguously larger primary sort-order location n-tuple:
adding the smallest unambiguously larger primary sort-order location n-tuple to the generated location n-tuples container; and
attempting to place the smallest unambiguously larger primary sort-order location n-tuple into the compactable tier set.

11. The method of claim 10, wherein attempting to place the smallest unambiguously larger primary sort-order location n-tuple into the compactable tier set includes:
when the current compactable tier is the most recently created compactable tier in the compactable tier set:
creating a new compactable tier, placing the smallest unambiguously larger primary sort-order location n-tuple into the newly-created compactable tier and adding the newly-created compactable tier to the compactable tier set.

12. The method of claim 10, further comprising:
when the current compactable tier is not the most recently created compactable tier in the compactable tier set:
attempting to place the smallest unambiguously larger primary sort-order location n-tuple into the compactable tier that was added to the compactable tier set immediately after the current compactable tier.

13. The method of claim 8, further comprising:
when the current compactable tier current location n-tuple is not the last location n-tuple in the current compactable tier:
adjusting the compactable tier location n-tuple counter so that it references the location n-tuple immediately subsequent to the current compactable tier current location n-tuple.

14. The method of claim 8, further comprising:
when the current compactable tier current location n-tuple is the last location n-tuple in the current compactable tier and the current compactable tier is not the first-created compactable tier in the compactable tier set:
adjusting the compactable tier countdown counter so that it references the compactable tier that was added to the compactable tier set immediately before the current compactable tier; and
adjusting the compactable tier location n-tuple counter so that it references the first location n-tuple in the compactable tier referenced by the current value of the compactable tier countdown counter.

15. A method of method of tentatively establishing or ruling out the existence of certain minimum length, minimum density common subsequences, the method comprising:
obtaining two or more sequences; and
populating a max tier set and a max tier corresponding tier set with respect to the component sequences.

16. The method of claim 15, further comprising:
creating a max tier entry counter;
initializing the max tier entry counter to reference one of the entries in the max tier set; and
attempting to identify one or more max tier location n-tuple sequences.

17. The method of claim 16, further comprising:
adjusting the max tier entry counter to reference a different entry in the max tier set.

18. A method of identifying one or more text intersection groups among two or more text segments, the method comprising:
obtaining two or more text segments;
designating a minimum length requirement;
designating a minimum density requirement; and
identifying one or more text intersection groups with respect to two or more of the text segments.

19. The method of claim 18, wherein identifying one or more text intersection groups with respect to two or more of the text segments includes use of one or more tier sets.

20. The method of claim 18, wherein identifying one or more text intersection groups with respect to two or more of the text segments includes:
designating a source text segment; and
comparing the source text segment to one or more target text segments.
